(19) United States
(12) Patent Application Publication
(10) Pub. No.: US 2009/0305204 A1
(43) Pub. Date: Dec. 10, 2009

(54) RELATIVELY LOW-COST VIRTUAL REALITY SYSTEM, METHOD, AND PROGRAM PRODUCT TO PERFORM TRAINING

(75) Inventors: Mark P. Connolly, San Antonio, TX (US); Erin Waldman, San Antonio, TX (US)

Correspondence Address: Mark P. Connolly, 3 Inview Cove, San Antonio, TX, 78248, US

(73) Assignee: INFORMA SYSTEMS INC, Boerne, TX (US)

(21) Appl. No.: 12/134,191

(22) Filed: Jun. 6, 2008

(51) Int. Cl. G09B 19/00

(52) U.S. Cl. 434/219

(57) ABSTRACT

A method for a virtual reality simulation for training using a computer system includes the steps of executing the virtual reality simulation on the computer system, manipulating an input device in a 3-dimensional space and recording acceleration and orientation of the input device along three axes during the manipulation. Position of the input device relative to a display of the virtual reality simulation along an axis extending from the input device to the display is recorded. The recording is transmitted to the computer system. The recording is used to interact with a virtual object on a background scene in the virtual reality simulation and includes comparing the recording to a signature associated with the virtual object and acting on results of the comparing. The method further includes using the recording to navigate on the background scene.

### CROSS-REFERENCE TO RELATED APPLICATIONS

The present Utility patent application claims priority benefit of the U.S. provisional application for patent Ser. No. 61031341 filed on Feb. 25, 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to a system for virtual reality simulation training. More specifically, the use of a relatively low-cost system to enable virtual reality simulation training to be created for hands-on learners.

### BACKGROUND OF THE INVENTION

The learning of tasks by a human learner typically requires the learner to perform numerous simultaneous motor-skills and thought processes. These individuals learn either on-the-job or by practical demonstrations performed in a classroom setting. These hands-on learners are often known as kinesthetic learners since they learn best by performing the tasks, principally with their hands. Other training methods such as online learning often fail to address the needs of these hands-on learners. Online learning typically presents the tasks that the learner must perform as a series of simple videos, images, or assessment type questions. This will not address the need for these individuals to learn by performing the hands-on tasks. This produces poor retention and unproductive outcomes.

Virtual reality, VR, is an attractive technology that may offer one solution to the need to provide hands-on learning that is not on-the-job or classroom based. This technology is used for games, virtual tours and other applications. However, for training simulations, VR is not commonly employed. Often, creating a VR simulation is very expensive since the simulation must be developed and customized for each particular training task. This does not lend itself to training applications, since the small potential audience of learners, does not satisfy a cost-benefit analysis.

However, there are several areas where VR training has been successfully employed. For medical and dental training there is a large volume of prior-art. Realistic VR surgical simulation allows comprehensive training without endangering patients' lives. A typical VR surgical simulator includes both hardware and software. The first generation, of these simulators, only used position sensors whereas more advanced simulators incorporate haptic devices that provide force feedback to generate the “feel” of medical instruments and the interaction of the instruments with an anatomical simulation. Other prior-art considers various types of interface devices to enable a user to interact with the simulation system in a realistic manner. For example, a feedback response is provided to the user, through the use of haptic devices, as they navigate through the VR simulation. Other publications describe in more detail how haptic devices can be used as part of medical procedures. For example, a medical procedure simulation system that utilizes VR technology and force feedback to provide an accurate and realistic simulation of endoscopic medical procedures.

A second and critical ingredient in the medical simulation prior-art is the computational engine that accepts the inputs from the input devices and displays the graphical representation of the surgical scene along with the force feedbacks for the haptic devices. These computational engines use mathematical models to simulate the interaction of the virtual tool with the viscoelastic soft tissue material.

This medical prior-art, focused on advanced medical simulation, suffers from several disadvantages. Firstly in many cases it employs haptic devices—a necessary requirement to simulate the “feel” of the procedure. For industrial or other training applications this level of sensitivity and interactivity, provided by haptic devices, is not required. Secondly the cost of creating these training simulations is extremely high. The medical industry can justify these costs, but other industries and applications typically cannot. Thirdly this medical prior-art often employs extremely complex computations to model the behavior of non-linear viscoelastic materials. This is not a requirement for the industrial or other training applications considered here. Finally this medical prior-art discloses particular instruments, devices, interfaces or simulations that apply to a particular simulation, or a particular class of simulations. It does not address the need to create lower-cost hands-on training for other applications.

In patient care, virtual reality simulation training is also used for a computerized education system for teaching patient care. It includes an interactive computer program for use with a simulator, such as a manikin, and virtual instruments to perform simulated patient care activity under the direction of the program. An audio chip on the computer is used to provide feedback to the user that confirms proper use of the virtual instruments on the simulator. This prior-art does encompass the use of input devices other than a mouse in simulation training, but it is specifically applied to medical patient care and does not consider other industries or applications. It also requires that the input device be coupled to the manikin so that feedback can be provided. It does not address the need to provide a simplified VR simulation system for other training applications.

In a further extension of patient care, the use of VR in rehabilitative care is described in the prior-art. In this case, a mixed reality simulation system that combines real objects, such as cups and pots, with the VR simulation. The real objects are fitted with sensors and the movement of the real objects is translated to the movement of the corresponding virtual objects on the screen. This system is a departure in VR since it incorporates real objects. Nevertheless it is applicable only to a very specific application, and requires that sensors be attached to the real objects. It also does not address the need for a relatively low-cost training system.

For maintenance training there is a large body of prior-art concerned with teaching procedural tasks. For example, virtual characters have been developed that provide an effective tool in real world applications, where users have to learn hand-operated tasks. Virtual training systems such as Steve adopted this approach. Steve is an autonomous, animated agent that cohabits the virtual world with students. Steve continuously monitors the state of the virtual world, periodically manipulating it through virtual actions. The objective is to help students learn to perform physical, procedural tasks. Steve can demonstrate tasks, explain his actions, as well as monitor students performing tasks, providing help when needed. The drawback is that Steve is primarily a tutoring system and does not consider the details of the interaction of the learner, through the input device with the VR scene. Therefore it does not address the kinesthetic needs of these hands-on learners.

Other more recent prior-art extends this work. For example, a virtual training system for maintenance of complex systems such as aircraft engines. This prior-art presents a training system that integrates the VR hardware with a 3D web simulation. In this study trainees interact with mechanical parts, using specific tools, e.g. snapper, screwdriver, etc, that are virtually simulated. The immersive VR implementation supports right hand interaction using a glove called a dataglove and a tracking sensor mounted on it. Collision detection between the virtual hand and the scene objects is computed in real-time. The interaction between the dataglove and the virtual scene follows a specification that uses collision detection sensors to determine hand-object proximity or contact.

This prior-art addresses a topic that is similar to that disclosed here. However it suffers from several shortcomings that will make it difficult to implement: Firstly, it requires the use of VRML modeling language to create the virtual scene. This is a very expensive undertaking since the VRML scene must be created using specific and expert software knowledge, a task that is beyond the skill of a typical trainer or subject matter expert. Secondly the system requires the use of a dataglove with virtual proximity sensors that detect collisions between the glove and an object within the VR simulation. Datagloves are expensive devices and are not widely used or accepted by learners as a result of usability and hygiene issues. Finally, the modeling of the interaction between the dataglove and the objects in the simulation is extremely complex since it requires the use of intensive collision detection computations. Consequently, this approach does not lend itself to relatively low-cost, simple VR simulations.

In the area of game based training, there is a large volume of prior-art that covers the issue of using high quality computer game software tools to develop training simulations. This so-called serious gaming, first person shooter or role playing, is primarily a simulation tool for combat and does not address hands-on learning. A similar game called Trauma Center Second Opinion was developed with the low-cost Wii input device from Nintendo. In this simulation the user assumes the role of the surgeon and uses the medical toolkit includes scalpels, forceps, defibrillator paddles and syringes to perform medical simulations. This prior-art is relevant since it addresses the need for hands-on learning, and also uses a low-cost input device. However this game system was created using specialist software that is beyond the skill of most trainers and subject matter experts and typically cannot be used as a tool to develop a hands-on training system.

There is also a large body of prior-art that considers the issue of online e-learning. In this e-learning art, there is no consideration of the user, or the input devices, other than a mouse for interacting with the display.

Other prior art has considered the role of virtual reality as a tool for e-learning. This prior-art looked at virtual landscapes where courseware is provided as an explorative learning approach. This prior-art is a typical implementation of virtual reality in e-learning, it considers a virtual landscape but does not address the issue of the interaction of the hands-on learner with this virtual landscape.

There are cases were simulation training was considered for other applications using an augmented reality to assist with training. In this augmented reality system a computer-generated image is superimposed on what the user is actually looking at. This is very useful for engineering assembly, and for training workers to assemble complex engineering structures. This does not consider how this type of approach can be implemented to provide hands-on training within a VR framework.

In view of the foregoing, there is a need for a technique to enable lower cost VR type training to be created for interaction with a hands-on learner.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an exemplary illustration of a basic system for performing the VR simulation training in accordance with an embodiment of the present invention;

FIG. 2 is an exemplary illustration of the input device and associated accelerations in accordance with an embodiment of the present invention;

FIG. 3 is an exemplary depiction of the relationship between the infrared camera and the beacon bar;

FIG. 4 depicts exemplary waveforms of acceleration data obtained from the input device;

FIG. 5 depicts exemplary waveforms of acceleration data obtained from the input device;

FIG. 6 is a diagram depicting an exemplary approach used to determine the distance from the input device to the beacon bar;

FIG. 7 is a diagram of exemplary acceleration waveforms corresponding to motions of the input device;

FIG. 8 depicts exemplary virtual objects used in the creation of the VR simulation;

FIG. 9 is a flow diagram depicting an exemplary process to create the VR simulation in accordance with an embodiment of the present invention;

FIG. 10 is a flow diagram depicting steps by a user when interacting with the VR training system in accordance with an embodiment of the present invention; and

FIG. 11 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a relatively low-cost virtual reality system to perform training is presented.

In one embodiment, a method for a virtual reality simulation for training using a computer system is presented. The method includes the steps of executing the virtual reality simulation on the computer system, manipulating an input device in a 3-dimensional space, recording acceleration and orientation of the input device during the manipulation, transmitting the recording to the computer system and using the recording to interact with a virtual object on a background scene in the virtual reality simulation. In another embodiment the step of recording further includes recording position of the input device relative to a display of the virtual reality simulation. Another embodiment further includes using the recording to navigate on the background scene. In still another embodiment, the step of using the recording to interact further includes comparing the recording to a signature associated with the virtual object and acting on results of the comparing. In various other embodiments the step of recording includes recording the acceleration and orientation along three axes, recording the position along an axis extending from the input device to the display, recording the position using data from an image sensor and calculating the position using a detected image from a beacon. Yet another embodiment further includes transmitting to the computer system data from user-activated controls on the input device. In another embodiment the virtual object is a 3-dimensional virtual object and the step of using the recording to interact further includes interacting in three dimensions. In still other embodiment, the background scene includes a panoramic view and the step of using the recording to navigate further includes scrolling a display of the panoramic view and using changes in the position to navigate forward and backward in the panoramic view.

In another embodiment a method for a virtual reality simulation for training using a computer system is presented. The method includes steps for executing the virtual reality simulation on the computer system, steps for manipulating an input device in a 3-dimensional space, steps for recording data during the manipulation of the input device, steps for transmitting the recording to the computer system and steps for using the recording to interact with a virtual object. Other embodiments further include steps for using the recording to navigate on a background scene and steps for transmitting to the computer system data from user-activated controls on the input device.

In another embodiment a system for a virtual reality simulation for training is presented. The system includes a computer system for executing the virtual reality simulation including a display. An input device is operable to be manipulated in a 3-dimensional space and to record acceleration and orientation during manipulation of the input device. The input device includes a transmitter for transmitting a recording of the manipulation to the computer system. A background scene of the virtual reality simulation including at least one virtual object is operable for interaction using the recording. In other embodiments, the input device is further operable to record position of the input device from the display and the background scene can be navigated using the recording. Yet another embodiment further including a signature associated with at least one virtual object wherein the recording can be compared to the signature to produce a result of the manipulation. In still another embodiment the input device is further operable to record acceleration and orientation along three axes. In another embodiment the input device further includes an image sensor for producing data for the position. Yet another embodiment further includes a beacon for emitting radiation that is detectable by the image sensor where the detectable radiation can be used in calculating the position. In various other embodiments, the input device further includes user-activated controls to provide additional data to be transmitted to the computer system, at least one virtual object is 3-dimensional and operable for interaction in three dimensions and the background scene includes a panoramic view.

In another embodiment a computer program product for a virtual reality simulation for training using a computer system is presented. The computer program product includes computer code for receiving a transmitted recording, from an input device, of acceleration and orientation of the input device during manipulation of the device in a 3-dimensional space. Computer code uses the recording to interact with a virtual object on a background scene in the virtual reality simulation. Computer code uses the recording to navigate on the background scene. Computer code compares the recording to a signature associated with the virtual object and acts on results of the comparing. A computer readable medium stores the computer code. Another embodiment further includes computer code for receiving a transmitted recording, from the input device, of position of the input device relative to a display of the virtual simulation. Another embodiment further includes computer code for receiving data from user-activated controls on the input device. Still other embodiment further include computer code for using the recording to interact with the virtual object in three dimensions and computer code for scrolling the background scene in response to navigating on the background screen.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Accordingly it is an aspect of a preferred embodiment of the present invention to provide a training method that can be used to create VR simulations at a relatively low cost. This has hitherto been difficult since creation of VR is an expensive undertaking. The type of training that is addressed by the present invention is hands-on training that typically requires the mastery of numerous simultaneous motor-skills and thought processes. It requires the learner to perform a series of tasks to successfully complete the training. For example, without limitation, this could be a mechanic using a wrench, a peace officer confronting an armed suspect, a machine operator manufacturing a new part, or a special-needs child who requires kinesthetic learning.

A preferred embodiment of the present invention uses a simple input device that is capable of being manipulated by a user during a training simulation. The input device can report the forces that it is producing as the user is manipulating it. In the preferred embodiment this input device can also report its orientation and also its position in space. The forces can be measured using accelerometers associated with the device. In other embodiments, the position and orientation of the device can also be measured using sensors associated with the device. In other embodiments, the input device can also contain further user-activated controls such as, without limitation, buttons, joysticks, scroll knobs or roller balls to provide additional user inputs. The primary input device is typically held in one hand, and optionally, a second input device possibly held in the other hand can also be used to provide additional information. In a preferred embodiment of the present invention, the input device is not tethered to a computer system and transmits the information that it reports wirelessly to the computer system.

In a preferred embodiment of the present invention, the information such as, without limitation, position, orientation, forces and button presses from the input device that are transmitted to the computer system are interpreted by the software code that resides in the computer system. The software code can perform numerous actions such as, without limitation, navigate the virtual scene, select objects, or act on a virtual object or a plurality of virtual objects that are displayed on the computer screen. Preferably, rules that are part of this software code are used to translate the inputs such as, without limitation, position, orientation, forces and button presses from the input device into actions on the VR simulation.

In a preferred embodiment of the present invention, the VR simulation comprises virtual objects within a virtual scene. The data from the input device can be used to simulate user navigation within the virtual scene. In the preferred embodiment the input device can be used as a virtual mouse pointer and can direct the user to different areas or regions of the virtual scene by changing the orientation of the input device, similar to a laser pointer. This type of navigation uses the orientation data provided by the input device as the user is manipulating it. In another embodiment the position of the input device can also be tracked and the movement of the device can be used to navigate the virtual scene. As the user moves the input device, for example, without limitation, from left to right, the user changes position within the virtual scene. In other embodiments, the user can navigate the scene using controls such as, without limitation, buttons, joysticks, scroll knobs or roller balls on the input devices.

In a preferred embodiment of the present invention, the input device can act on the virtual objects within the virtual scene. The software code preferably uses rules to translate the inputs from the input device into a response of the virtual objects. In a preferred embodiment these rules are provided by comparing the data from the input device with known signatures for various actions stored within the computer system. In another embodiment the response of the virtual objects is predicted from the laws of motion and deformation. This response can be, for example, without limitation, a simple translation, rotation or deformation. The virtual object can also be constrained such as, without limitation, to prevent movement in one, many or all directions.

In the preferred embodiment of the present invention, the virtual scene can be constructed from a panoramic image that provides a 3D scene. This panoramic image can be created by joining a series of photographs by means such as, without limitation using so-called stitching software, or from a camera capable of creating the panoramic images in a single step without post processing. In other embodiments, the virtual scene can be constructed by means such as, without limitation, using a traditional 3D VR language such as Virtual Reality Modeling Language, VRML or from a digital image background.

Embodiments, in accordance with the present invention, for performing the VR simulation training, have numerous advantages. Some of these advantages are that the input devices that can report and transmit their location, orientation and the forces that they generate through user manipulation are readily available at a low cost. The virtual objects can be created and programmed to respond in a very flexible and realistic manner to the inputs from the input device. For example virtual objects, such as, without limitation wrenches or spanners can be created and can be easily reused in alternative virtual reality scenes. The data from the input device can be used to simulate navigation about the virtual scene in a realistic manner. The background scene can be constructed from simple images, or from panoramic images that is a relatively low-cost alternative to geometry-based software modeling languages in many practical application.

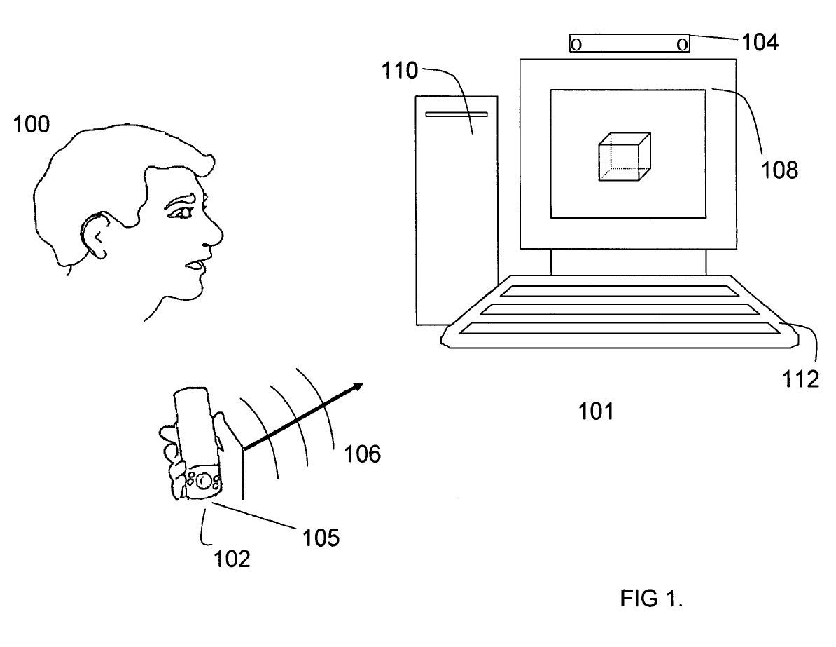

FIG. 1 is an exemplary illustration of a basic system for performing the VR simulation training in accordance with an embodiment of the present invention. In a preferred embodiment, a user 100 manipulates an input device 102. The input device contains an accelerometer or a number of accelerometers that tracks the forces exerted on the input device 102 by the user. The input device can also contain a sensor or a number of sensors (not shown) that also tracks the orientation and/or the position in space of the input device. The input device may also contain user-activated controls 105 such as, without limitation, arrow buttons, simple buttons with alphanumeric characters, joysticks, scroll knobs or roller balls to provide additional user inputs. In alternative embodiments, another secondary input device (not shown) could be used with the user's other hand. This input device could be identical to the primary input device, or could be an alternative input device that provides additional user input. In the preferred embodiment, multiple accelerometers (not shown) are used in conjunction with input device 102 that can measure the acceleration in different directions. In this preferred embodiment, input device 102 is not tethered to a computer system 101 and information is sent from input device 102 to computer system 101 through a wireless communication interface 106. The computer system 101 that receives the transmission from the communication interface 106 includes a monitor 108, a base computer 110 which may include, without limitation, data storage storing software for operating the system in accordance with embodiments of the invention, one or more processors for executing the software, associated memory, communication hardware and other hardware typically found in a computer, and a keyboard 112. Hardware for computer system 101 can be typically implemented by a conventional or commercially available workstation. The user 100 manipulates the input device 102 while observing the effect of the interaction on the computer monitor 108. Beacon bar 104 provides orientation reference data to input device 102. In other embodiments, the computer system responds to the manipulation and provides feedback or data to the input device as the user is manipulating it. Input device 102 can use this feedback or data to provide additional sensory feedback to user 100 in the form of, without limitation, haptic, audible and visual feedbacks. This feedback can be used in some embodiments, without limitation, to alert the user of a correct or incorrect, or non-desirable, action as they interact with the VR simulation.

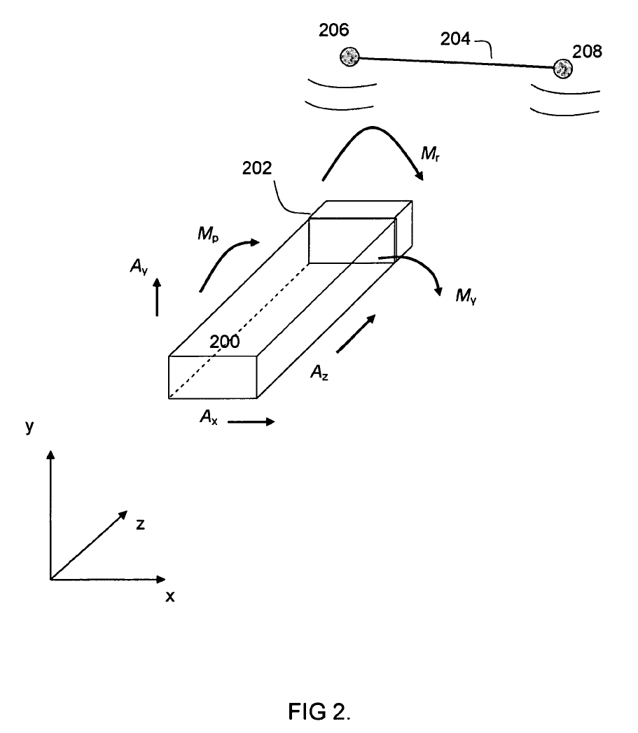

FIG. 2 is an exemplary illustration of the input device and associated accelerations in accordance with an embodiment of the present invention. In the preferred embodiment, the input device 200 contains 3-axis accelerometers that will report back the instantaneous force imparted on the controller by the user holding it. Input device 200 measures the accelerations in the x, y and z directions, designated as Aₓ, A_{y} and A_{z}. This information is supplemented by an infrared sensitive camera 202 mounted on the front of the input device 200. A pair of infrared emitters 206 and 208 that emit radiation can be positioned about 5 meters from the input device on a rod called a beacon bar 204. In the preferred embodiment the beacon bar 204 is about 20 cm in length and features two emitters 206 and 208 arranged at each end of the bar. The emitters can be comprised of one or more LEDs. The beacon bar is typically placed on top of the computer monitor 108. Beacon bar 204 can provide orientation reference data to input device 200. Although in the preferred embodiment input device 200 is sensitive to infrared radiation, other sources and sensor pairs could be used such as, without limitation, other forms of electromagnetic radiation or waves emanating from sources such as ultrasonic devices.

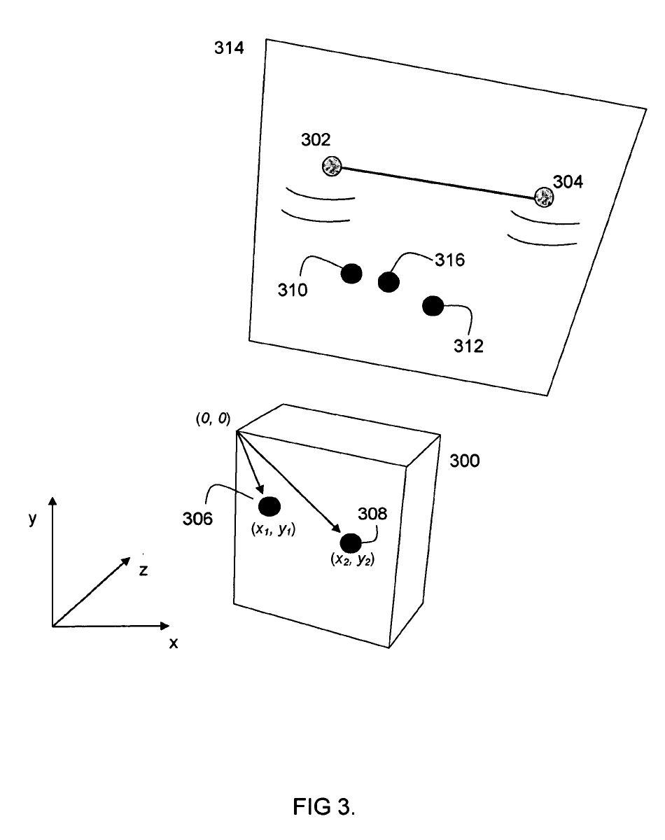

FIG. 3 is an exemplary depiction of the relationship between the infrared camera and the beacon bar. In the preferred embodiment the input device contains a one mega pixel image camera 300 that is used as an infrared sensor to locate the beacon bar's emitters in it's field of view. The dimensions of the spacing between the emitters on the beacon bar is known and the input device can calculate its orientation in space relative to the infrared signal emitted by the beacon bar emitters 302 and 304. The detected emitters are shown, by way of example, as the points 306 and 308 respectively on the image camera 300 with coordinates (x₁, y₁) and (x₂, y₂) as shown. These locations correspond to the corresponding points 310 and 312 on a plane 314 of the sensor bar. To obtain a single cursor location on plane 314 the average of the two points 310 and 312 can be used and is indicated as cursor point 316. Cursor point 316 which tracks the orientation of the input device can be used as a mouse pointer where the input device acts as an un-tethered mouse. This enables the user to manipulate objects and move around the virtual scene. In the preferred embodiment, 2 emitters are used on the beacon bar. In other embodiments additional emitters or other beacons could be used to provide additional location information and the additional emitters and concomitant data can enable more accurate positioning of the input device in 3-D space.

This information captured by the infrared camera is in addition to, and supplemented by, the 3-axis acceleration data. In the preferred embodiment, all of the accelerations, Aₓ, A_{y} and A_{z}, are recorded by input device 102 and transmitted to the computer system 101 through the interface device 106. However in other embodiments it may not be possible or desirable to record and transmit all of these forces. To perform actions on the virtual objects at least one force should be reported from the input device 102 to the computer system 101. The communication between the input device 102 and the computer system 101 can be performed using a communication interface 106. This communication interface 106 can, for example, without limitation, be infrared data communication, Bluetooth, or wireless LAN.

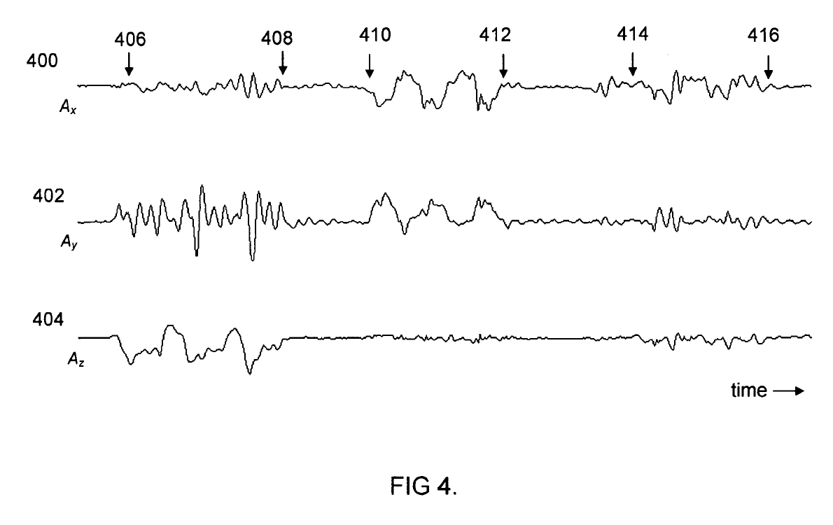

FIG. 4 depicts exemplary waveforms of acceleration data obtained from the input device. This data from input device 102 is transmitted to the computer system 101 via communication interface 106. This data shows the acceleration in the x direction 400, y direction 402 and z direction 404 as a function of time. These inputs are not normally displayed on the computer monitor but are shown here to illustrate the type of acceleration data that is produced by the actions of the user on the input device. In a preferred embodiment as shown in FIG. 4 the input device provides the accelerations in the different directions Aₓ, A_{y} and A_{z} as a function of time. However other embodiments may only use the average acceleration or the acceleration data in only one direction.

In the preferred embodiment the input device can also determine the angular accelerations in the pitch, roll and yaw directions, designated as Mₚ, Mᵣ and M_{y} respectively in FIG. 2. The absolute values of the angular accelerations typically cannot be determined, since this would require knowledge of the moments of inertia. However movement of the input device, in the pitch, roll and yaw directions, can be inferred from an analysis of the 3-axis accelerometer data. In most training applications this is adequate since a roll action would simulate a user turning a handle, a pitch movement could signify a user digging or lifting an object. In these cases the absolute values are not important but recognizing the action is. As shown in FIG. 4 the pitch motion starts at 406 and ends at 408. Roll motion starts at 410 and ends at 412. Finally, yaw motion starts at 414 and ends at 416. As FIG. 4 shows each of these angular motion primarily produces output on two of the three accelerometers. The pitch action affects the y and z accelerometers, roll x and y, and yaw x and z. The computer code that resides on the computer system 101, recognizes each of these motion signatures and can interpret the appropriate motion. This is important when using the device as a learning tool. For example, if it is required to turn an object then the roll signature 410 to 412 can be used.

FIG. 4 demonstrated how the type of motion can be determined from the input device. It is also possible to determine the orientation of the input device from the accelerometer data, since the accelerometers measure the acceleration due to gravity (g) and any change in the position relative to the direction of g, y direction in FIG. 2, will be reflected in the accelerometer readings. The pitch and roll can be determined from the accelerometer data since these motion directions are sensitive to the acceleration due to gravity and movement in these directions will produce changes in the accelerometer outputs. Therefore, if needed, the orientation in the pitch and roll direction can be determined from the accelerometer data alone.

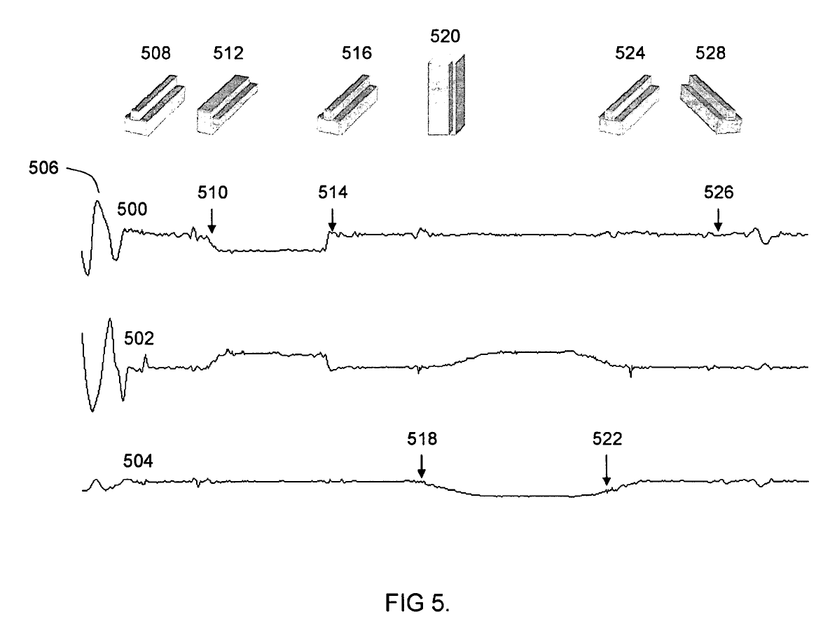

FIG. 5 depicts exemplary waveforms of acceleration data obtained from the input device. In the first part of the acceleration data, 506 the input device was shaken randomly by the user. The input device was then returned to it reference location at rest on a flat surface shown in 508. FIG. 5 shows the effect on the accelerometers, in waveforms 500, 502 and 504, of the user producing a roll movement at 510, then letting the device rest after having been turned 90 degrees to position 512. The device is then returned to its reference position at 516 and the corresponding acceleration data shown at 514. It is then subject to a pitch motion at 518, so that the device is standing upright at position 520. It is then returned to the reference position at 524 and is then subject to a yaw motion at 526 and the corresponding position 528. From FIG. 5 it is apparent that the orientation in the roll and pitch direction can be determined from the input device alone, since movement in the roll and pitch directions will change the orientation of the accelerometers with reference to the direction of gravity. Yaw orientation cannot usually be determined since this direction is perpendicular to the direction of gravity.

In the embodiment shown in FIG. 2, the input device is used as a pointing device. However, from a careful analysis of the data, it is possible to determine the distance of the input device from the beacon bar and the computer monitor on which it is typically placed. This is an important enhancement since it is possible to use the movement of the input device to navigate within the virtual scene in the z direction. For example as the user moves the input device towards the computer monitor, and the beacon bar, the user can navigate forward within the virtual scene.

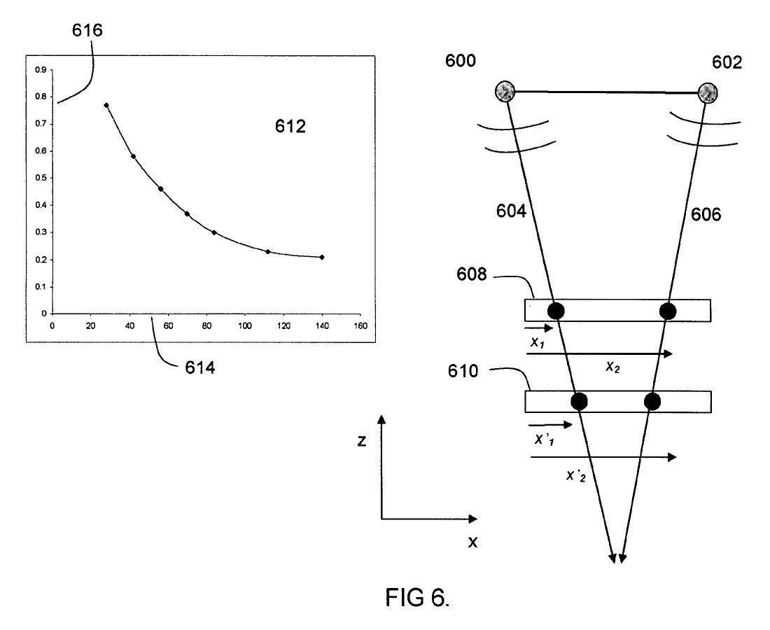

FIG. 6 is a diagram depicting an exemplary approach used to determine the distance from the input device to the beacon bar. In FIG. 6 emitters 600 and 602 emits infrared beams 604 and 606 respectively. The beams strike infrared camera 608 at positions that are a distance x₁ and x₂ from the left edge. When the input device is moved further away from the computer monitor, and the beacon bar to position 610 beams 604 and 606 strike the infrared sensor at positions that are a distance x′₁ and x′₂ from the left edge. It is clear that the further the input device is from the beacon bar, the distance between the two infrared beams as they strike the infrared camera decreases. When the infrared camera is at a far distance from the emitters, the beams will meet at a point. When the infrared camera is close to the beacon bar the beams will meet at the sensor edge, until at very close distances the beams are outside the field of view of the input device. The distance between position x₁ and x₂ can be used to infer the distance from the beacon bar. Graph 612 illustrates a calibration study performed to relate the distance between the x positions where the beams strikes the camera, x₁ and x₂, and the distance from the beacon bar. The horizontal axis 614 is the distance of the input device from the beacon bar and the vertical axis 616 is the distance, in normalized units, between the beam strikes on the infrared camera. This information can be used to determine the distance of the input device from the beacon bar. This calibration information is stored in the computer code that is on the computer system 101 and is used to analyze the input data and predict the distance of the input device from the beacon bar. Other co-ordinates, x and y, of the input device in space, typically cannot be determined from the data provided by the infrared sensors using a single beacon bar with two emitters. The two emitters mounted on the beacon bar generally do not provide sufficient information to resolve the position of the input device in the x and y plane. It is difficult to distinguish between changing the orientation of the input device, as in using the device as a mouse pointer, and moving it from left to right or up and down, since both forms of motion can produce identical changes in the measured position of the beams on the infrared camera. In alternate embodiments, x and y position information of the input device can be obtained by using additional beacons.

The VR simulation is comprised of a virtual scene in which includes placed virtual objects that will be manipulated by the user with the input device. The virtual scene can be constructed in a number of ways, such as, without limitation, using VRML, or a commercial software package that typically use geometric models. In the preferred embodiment the virtual scene is constructed from panoramic images. These images have an exceptionally wide field of view comparable to, or greater than, that of the human eye, about 160° by 75°, while maintaining detail across the entire picture. There are many types of panoramic formats available such as cylindrical, spherical or cubic and any of these formats can be used. In the preferred embodiment spherical panoramas are used. Standard industry methodologies can be used to construct the panoramic images and are described here. The first step is to obtain photographic images of the desired scene. A digital camera with a fisheye lens, such as, without limitation, a Peleng 3.5/8 mm can be used to obtain a very wide field of view digital photograph. This lens has a field of view of approximately 180°. Other lenses with other fields of view and other types of cameras can be used. Although only two images are required to obtain a full 360° panorama, the approach used here was to construct the panorama using 4 images taken 90° degrees apart. After the images were obtained they were then stitched together using commercial stitching software such as PTGUI that is capable of generating panoramic spherical images. The output of this program is a spherical image. One skilled in the art will readily recognize, in light of the present invention, that there are multiplicity of suitable software programs available to enable these images to be incorporated as part of a panoramic scene and these programs can be used as part of the computer code used to render the virtual scene.

This panoramic image represents a virtual scene from the viewpoint of the camera location. The virtual objects are added to this scene by placing the objects within a layer above a background scene. The background scene can be created, for example, without limitation, in Adobe flash format since this format supports layering of objects. The virtual objects can be simple or animated images or even an interactive 3D object created using, for example, without limitation, Adobe flash, AS3, C, C++ or other programming language. The virtual objects reside within the virtual scene ready to be manipulated by the input device

The user interacts with the VR simulation in a number of ways. For example, without limitation, the user can navigate the virtual scene, or the user can select an object within the virtual scene, or can perform an action on an object within the virtual scene. To navigate the virtual scene the user manipulates the input device. Navigation involves moving left, right, up, down and into or out of the scene. The user can also navigate to other regions or other scenes by hyperlinking on hotspots within the virtual scene. To move left, right, up or down the user can use the virtual mouse, controlled by orientating the input device and point in the direction that the user wishes to move. The panoramic image will scroll to make that region visible. For example if the user points to the left region of the panoramic image the panoramic image will scroll to the right to make more of the panorama visible. In this mode the user navigates through the panorama using the input device as a pointer—similar to a laser pointer. In an alternative embodiment the user can physically move the input device in the direction that he wishes to move within the scene and the panorama will scroll accordingly. For example to move left the user may physically move the input device to the left and the mouse pointer will move to the left on the computer monitor. To move into or out of the scene the user can physically move the input device towards the screen and to move out the user can move the input device out of the screen using the approach described in FIG. 6. In alternative embodiments, the user can navigate the virtual scene using user-activated controls 105 such as, without limitation, arrow buttons, simple buttons with alphanumeric characters, joysticks, scroll knobs or roller balls placed on input device 102. Furthermore it is also possible to use a combination of all of the above methods to navigate the virtual scene in other embodiments.

Some or all of the data from the input devices acts on the virtual objects. These virtual objects are symbolic representations of real objects, such as, without limitation, a spanner, a hammer, or a door handle and are displayed on the computer monitor 108 to be manipulated through the input device by the user. The virtual objects can be created using computer programs such as, without limitation, C, C++, visual basic or AS3. The 3-axes acceleration data, Aₓ, A_{y} and A_{z}, in FIG. 2, together with orientation data obtained from the infrared camera can be translated to forces and torques acting on the virtual objects using a series of waveforms of known motions, hereinafter referred to as signatures. These signatures, obtained from calibration studies, are used to infer the actions to be performed on the virtual objects. These signatures are composed of known responses to user actions with the input device. For example, if the object were a wrench then the object would be programmed to recognize the signature from a turn action. Common actions that a user could perform are categorized and input data signatures are developed for each of these actions.

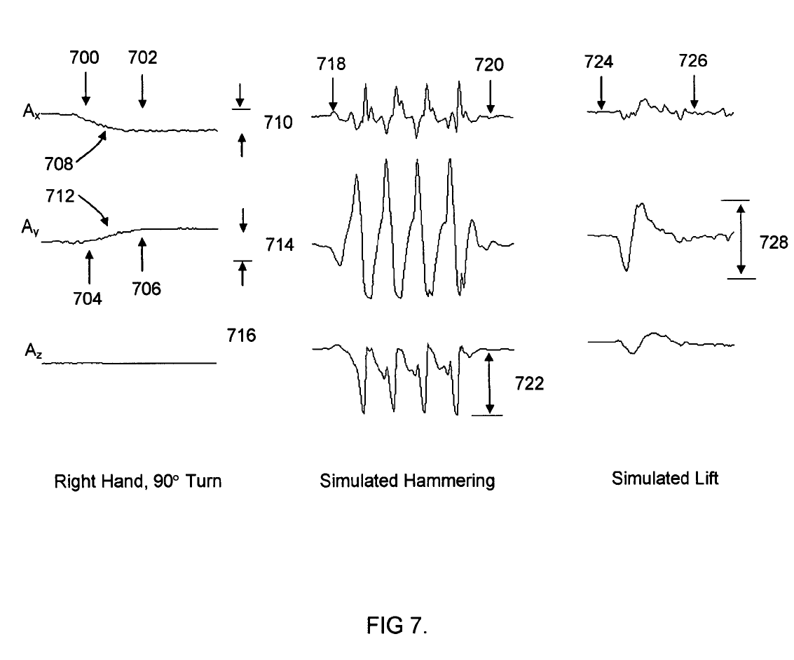

FIG. 7 is a diagram of exemplary acceleration waveforms corresponding to motions of the input device. In the case of turning the input device 90° to the right, to simulate turning a handle or tightening a screw, the x axis accelerometer value, Aₓ, changes as the right turn starts at 700 and ends at 702, similarly y axis accelerometer value A_{y} changes from 704 to 706. There is no change in the z axis accelerometer data, A_{z}. since this turn action is perpendicular to the z axis plane. Similarly FIG. 7 also shows the effect of hammering, in this case moving the input device up and down rapidly, primarily in the y direction. The hammering simulation starts at 718 and ends at 720. The third action in FIG. 7 is a simulated lift, which comprised of a single rapid movement upwards (in the y direction) for the input device. The action starts at 724 and ends at 726. As shown from these figures each of these waveforms has unique features that enable them to be a signature for the action. The approach used to identify each of these unique signatures is to extract key features from each action and to compare an unknown user action against these features. For example, for the turn action the following key features are used to identify the turn; rate of change of the x-axis accelerometer 708, maximum change of the acceleration 710, rate of change of the y-axis accelerometer 712 and maximum value of the y-axis accelerometer value 714. Furthermore for a turn perpendicular to the z plane there is no significant change in the z axis acceleration A_{z} 716. The hammering action exhibits a pronounced A_{z} signature 722, and for the lifting action a unique change in the accelerometer in the y direction Ay 728. These features are typically selected to achieve a high rate of accuracy in the ability of the computer code to recognize and categorize the user action. In most cases the signature can be resolved from the acceleration data alone. In other embodiments the position data from the infrared camera can be added to the signature to increase the rate of accuracy.

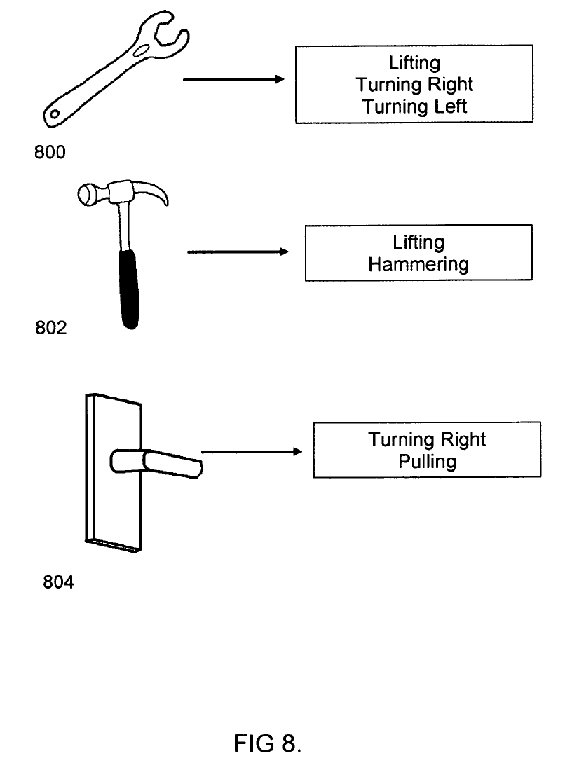

FIG. 8 depicts exemplary virtual objects used in the creation of the VR simulation. Some examples of virtual objects that can be used in the simulation are a spanner 800, hammer 802, and door handle 804. One skilled in the art will, in light of the present invention, realize that a multiplicity of alternative and suitable virtual objects can be created where the virtual objects pertain to the training goals of the VR simulation. Each of the actions, to be applied to the virtual objects, is assigned the motion signature indicated in the figure. If the object is selected and subjected to these actions from the input device then the object will respond in a programmed manner. Upon having successfully completed the action, the response is selectable within the computer program, such as, without limitation, hyperlinking to another scene, opening the door in the case of the handle 804, or providing feedback to the user that the task was successfully completed.

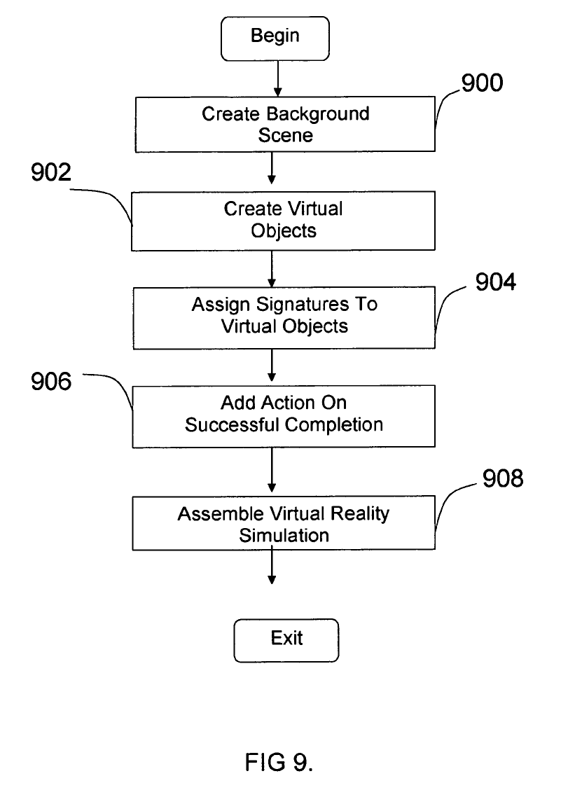

FIG. 9 is a flow diagram depicting an exemplary process to create the VR simulation in accordance with an embodiment of the present invention. In step 900 a background scene is created and added to the VR simulation. The background scene could be, for example, without limitation, created from a simple image file, a panoramic image or a geometry based image file. The virtual reality objects are created in step 902 and can comprise image files, or animated image files. In the preferred embodiment, of the present invention, the virtual reality objects can be a 3-dimensional object that can be manipulated in 3D space by the user. The signatures that correspond to the desired actions that the user must perform on the objects are assigned to the objects in step 904. The actions that will be performed on successful completion of the desired actions are added to the virtual objects in step 906, for example, but without limitation, this could be hyperlinking to another scene, or providing feedback to the user. In step 908 the virtual reality objects are added to the background scene to create the VR simulation. This simulation can be delivered in a computer code on a computer readable medium that can be executed by computer system 101 or delivered via the Internet to computer system 101 to be executed by computer system 101. It will be readily apparent, in light of the present invention, to one skilled in the art, that a variety of suitable programming languages, such as, without limitation Adobe Flash, can be employed in the creation of the VR Simulation.

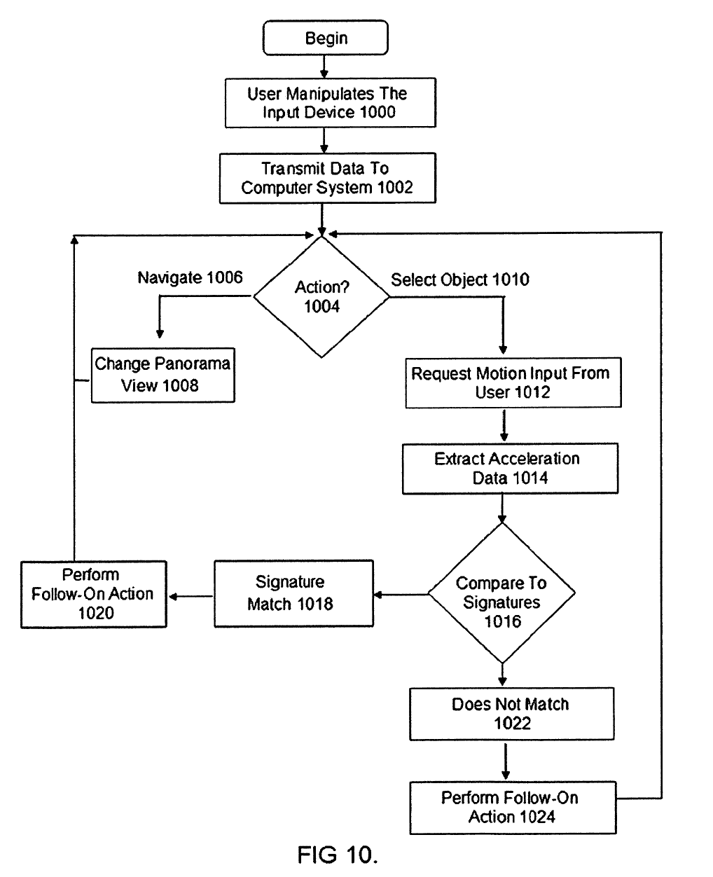

FIG. 10 is a flow diagram depicting steps by a user when interacting with the VR training system in accordance with an embodiment of the present invention. The VR simulation comprises a virtual scene together with a number of virtual objects as previously described in FIG. 9. In the preferred embodiment the virtual scene comprises a panoramic image. The user manipulates the input device in step 1000 and the data from the input device is transmitted to the computer system in step 1002 and is interpreted by the computer code that resides on computer system 101. The computer system reads the accelerometer data, the position data from the infrared camera, and also user-activated controls and determines what action to perform in step 1004. In a preferred embodiment one input device is used, in alternative embodiments a plurality of input devices can be used. The user can chose to navigate the scene 1006, or select an object 1010. To navigate a scene the user positions the mouse on a region of the scene that supports navigation. For the panoramic background images, this will be the left, right, or top and bottom regions. The creator of the training selects the size of these regions. Other navigation regions can be created such as, without limitation, areas of the panoramic image that will enable the user to navigate to another part of the panorama or to an alternative panorama. If the user navigates within the panorama then the panorama view will change to allow the user to view that portion of the panorama. For example if the user moves the mouse pointer to the left edge, the panoramic scene will scroll to the right. The user can also navigate within a scene by moving the input device closer to the beacon bar, and the computer monitor, or further away from the beacon bar to simulate moving out of the scene. This is performed using the approach described in detail in FIG. 6. After navigation has completed the computer code within the VR simulation will await the next user input.

If the user selects a virtual object 1010 then the object will request motion input from the user in step 1012. This can be, without limitation, in the form of a hint or by some other process that directs the user to perform the action. For some objects no hinting is required since the actions to be performed will be self-descriptive from the object, as in a hammer 802. The computer software will extract the acceleration data in step 1014 and compare this information to the signatures assigned to the selected object in step 1016. If the signatures match in 1018 then a follow-on action will be performed in step 1020. The follow-on action can be, without limitation, a simple message, navigation to another scene or some other process or recording successful action by the user. If the signatures do not match in 1022 then a follow-on action can also be performed for this case in step 1024. The follow-on action can be, without limitation, a simple message, navigation to another scene or some other process, requesting the user to repeat the motion input or recording unsuccessful action by the user. After the follow-on action has been performed the computer code awaits the next user input.

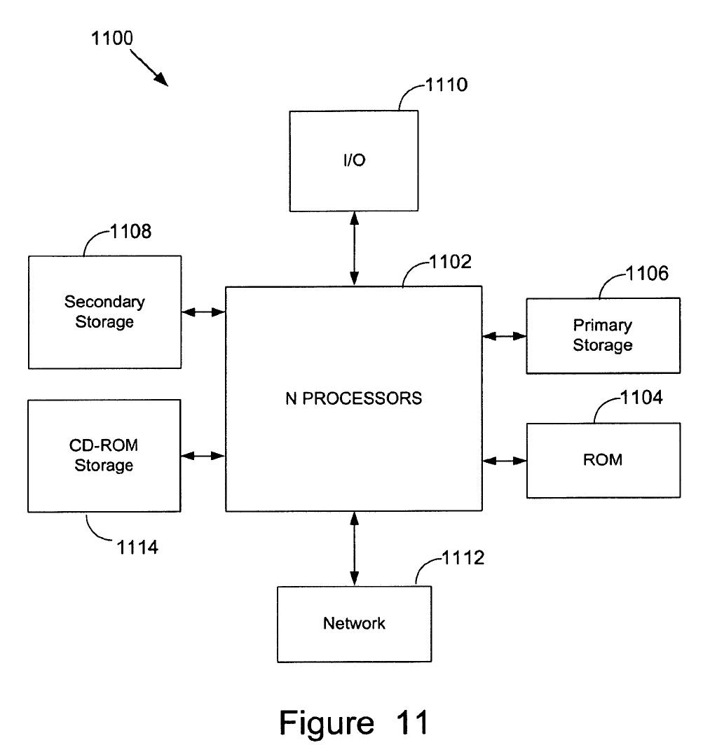

FIG. 11 illustrates a typical computer system that, when appropriately configured or designed, can serve as a computer system in which the invention may be embodied. The computer system 1100 includes any number of processors 1102 (also referred to as central processing units, or CPUs) that are coupled to storage devices including primary storage 1106 (typically a random access memory, or RAM), primary storage 1104 (typically a read only memory, or ROM). CPU 1102 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 1104 acts to transfer data and instructions uni-directionally to the CPU and primary storage 1106 is used typically to transfer data and instructions in a bi-directional manner. Both of these primary storage devices may include any suitable computer-readable media such as those described above. A mass storage device 1108 may also be coupled bi-directionally to CPU 1102 and provides additional data storage capacity and may include any of the computer-readable media described above. Mass storage device 1108 may be used to store programs, data and the like and is typically a secondary storage medium such as a hard disk. It will be appreciated that the information retained within the mass storage device 1108, may, in appropriate cases, be incorporated in standard fashion as part of primary storage 1106 as virtual memory. A specific mass storage device such as a CD-ROM 1114 may also pass data uni-directionally to the CPU.

CPU 1102 may also be coupled to an interface 1110 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1102 optionally may be coupled to an external device such as a database or a computer or telecommunications or internet network using an external connection as shown generally at 1112, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112(6) it is intended that the corresponding means for and/or steps for carrying out the claimed function also include those embodiments, and equivalents, as contemplated above that implement at least some novel aspects and objects of the present invention in the jurisdiction of the USA. For example, the delivering of the computer code via the Internet may be performed and/or located outside of the jurisdiction of the USA while the remaining method steps and/or system components of the forgoing embodiments are typically required to be located/performed in the US for practical considerations. It is further contemplated that some implementations creating the VR simulation may also be implemented outside the United States where obtaining photographic images of the desired scene may be performed and/or located outside of the jurisdiction of the USA.

Having fully described at least one embodiment of the present invention, other equivalent or alternative methods of implementing according to the present invention will be apparent to those skilled in the art. The invention has been described above by way of illustration, and the specific embodiments disclosed are not intended to limit the invention to the particular forms disclosed. For example, without limitation, the embodiments described in the foregoing were directed to one user of the VR simulation; however, it is contemplated that multiple users may utilize the VR simulation for training such as, without limitation, team training and is within the scope of the present invention. The invention is thus to cover all modifications, equivalents, and alternatives falling within the spirit and scope of the following claims.

What is claimed is:

1. A method for a virtual reality simulation for training using a computer system, the method comprising the steps of:
initiating the execution of the virtual reality simulation on the computer system;
manipulating an input device in a 3-dimensional space;
recording acceleration and orientation of said input device during said manipulation;
transmitting said recording to the computer system; and
using said recording to interact with a virtual object on a background scene in the virtual reality simulation.

2. The method as recited in claim 1, wherein said step of recording further comprises recording position of said input device relative to a display of the virtual reality simulation.

3. The method as recited in claim 2, further comprising using said recording to navigate on said background scene.

4. The method as recited in claim 1, wherein said step of using said recording to interact further comprises:
comparing said recording to a signature associated with said virtual object; and
acting on results of said comparing.

5. The method as recited in claim 1, wherein said step of recording comprises recording said acceleration and orientation along three axes.

6. The method as recited in claim 5, wherein said step of recording further comprises recording said position along an axis extending from said input device to said display.

7. The method as recited in claim 6, wherein said step of recording further comprises recording said position using data from an image sensor.

8. The method as recited in claim 7, wherein said step of recording further comprises calculating said position using a detected image from a beacon.

9. The method as recited in claim 1, further comprising transmitting to the computer system data from user-activated controls on said input device.

10. The method as recited in claim 1, wherein said virtual object is a 3-dimensional virtual object and said step of using said recording to interact further comprises interacting in three dimensions.

11. The method as recited in claim 3, wherein said background scene comprises a panoramic view and said step of using said recording to navigate further comprises scrolling a display of said panoramic view.

12. The method as recited in claim 11, wherein said step of using said recording to navigate further comprises using changes in said position to navigate forward and backward in said panoramic view.

13. A method for a virtual reality simulation for training using a computer system, the method comprising:
steps for executing the virtual reality simulation on the computer system;
steps for manipulating an input device in a 3-dimensional space;
steps for recording data during said manipulation of said input device;
steps for transmitting said recording to the computer system; and
steps for using said recording to interact with a virtual object.

14. The method as recited in claim 13, further comprising steps for using said recording to navigate on a background scene.

15. The method as recited in claim 13, further comprising steps for transmitting to the computer system data from user-activated controls on said input device.

16. A system for a virtual reality simulation for training, the system comprising:
a computer system for executing the virtual reality simulation comprising a display;
an input device operable to be manipulated in a 3-dimensional space and to record acceleration and orientation during manipulation of said input device, said input device comprising a transmitter for transmitting a recording of said manipulation to said computer system; and
a background scene of the virtual reality simulation comprising at least one virtual object operable for interaction using said recording.

17. The system as recited in claim 16, wherein said input device is further operable to record position of said input device from said display.

18. The system as recited in claim 17, wherein said background scene can be navigated using said recording.

19. The system as recited in claim 16, further comprising a signature associated with said at least one virtual object wherein said recording can be compared to said signature to produce a result of said manipulation.

20. The system as recited in claim 16, wherein said input device is further operable to record acceleration and orientation along three axes.

21. The system as recited in claim 17, wherein said input device further comprises an image sensor for producing data for said position.

22. The system as recited in claim 21, further comprising a beacon for emitting a radiation that is detectable by said image sensor where said detectable radiation can be used in calculating said position.

23. The system as recited in claim 16, wherein said input device further comprises user-activated controls to provide additional data to be transmitted to said computer system.

24. The system as recited in claim 16, wherein said at least one virtual object is 3-dimensional and operable for interaction in three dimensions.

25. The system as recited in claim 16, wherein said background scene comprises a panoramic view.

26. A computer program product for a virtual reality simulation for training using a computer system, the computer program product comprising:
computer code for receiving a transmitted recording, from an input device, of acceleration and orientation of said input device during manipulation of said device in a 3-dimensional space;
computer code for using said recording to interact with a virtual object on a background scene in the virtual reality simulation;
computer code for using said recording to navigate on said background scene;
computer code for comparing said recording to a signature associated with said virtual object and acting on results of said comparing; and
a computer readable medium that stores the computer code.

27. The computer program product as recited in claim 26, further comprising computer code for receiving a transmitted recording, from said input device, of position of said input device relative to a display of the virtual simulation.

28. The computer program product as recited in claim 26, further comprising computer code for receiving data from user-activated controls on said input device.

29. The computer program product as recited in claim 26, further comprising computer code for using said recording to interact with said virtual object in three dimensions.

30. The computer program product as recited in claim 26, further comprising computer code for scrolling said background scene in response to navigating on said background screen.
